(19) United States
(12) Patent Application Publication
(10) Pub. No.: US 2023/0334072 A1
(43) Pub. Date: Oct. 19, 2023

(54) AUTOMATIC QUESTION ANSWERING SYSTEM AND QUESTION-ANSWER PAIR DATA GENERATION METHOD

(71) Applicant: Hitachi, Ltd., Tokyo (JP)

(72) Inventors: Keiichi MATSUZAWA, Tokyo (JP); Mitsuo HAYASAKA, Tokyo (JP)

(73) Assignee: Hitachi, Ltd., Tokyo (JP)

(21) Appl. No.: 18/170,614

(22) Filed: Feb. 17, 2023

(30) Foreign Application Priority Data
Apr. 18, 2022 (JP) 2022-068535

(51) Int. Cl. G06F 16/332; G06F 16/33

(52) U.S. Cl. CPC G06F 16/3329; G06F 16/3326; G06F 16/3349

(57) ABSTRACT

A customer inputs a question sentence indicating a problem that the customer needs to resolve, to an automatic question answering system, and the system answers the question sentence. A history of the conversation is recorded in the system as conversation history data. When the system fails to give a suitable answer in a question-and-answer session, the system escalates the question to a support representative. In such a case, the question sentences and an answer sentence given by the support representative to resolve the problem are added to question-answer pair data as new question-answer pairs. The accuracy of automatic question answering is thus enhanced.

### BACKGROUND OF THE INVENTION

### 1. Field of the Invention

There is an automatic question answering system configured to give a customer (questioner) an appropriate answer by repeatedly receiving questions from the customer via an information processing apparatus and answering the questions. The present invention enables the automatic question answering system to automatically create data including pairs of expected questions and corresponding answer sentences, with reduced man-hours. The expected questions include question sentences with various expressions that the customer is likely to ask.

### 2. Description of the Related Art

Along with the development of artificial intelligence (AI) technologies and natural language processing technologies, an automatic question answering system using a chatbot or the like has been widely used. The automatic question answering system automatically sends any answer to a question sentence that a user has created in an informal style by using an information processing apparatus. In recent years, the automatic question answering system has widely been used in companies to provide product customer support.

The main purpose of using the automatic question answering system is to answer inquiries from customers accurately and quickly and resolve their problems promptly. Promptly resolving problems of customers leads to a decrease in customer support costs on the company side and is also excellent in terms of energy conservation. Hence, this is highly beneficial to not only the customers but also the companies.

Many of the automatic question answering systems prepare a large number of expected questions, which are questions that customers are likely to ask, and corresponding answer sentences in advance. When a customer makes an inquiry, such an automatic question answering system searches the expected questions for an expected question close to the contents of the inquiry and gives the customer an answer sentence corresponding to the expected question. When a plurality of customers make the same inquiry, they often use various question sentences with different words or word orders. Therefore, in order to answer inquiries from a large number of customers accurately and quickly, the automatic question answering systems need to prepare many pairs of expected questions and answer sentences.

Such an automatic question answering system generally needs a large number of man-hours to prepare expected questions and answer sentences. Accordingly, a technique for automatically generating expected questions and answer sentences from existing documents has been proposed. JP-2020-080025-A discloses a technology for automatically generating expected questions and answer sentences by converting the contents of semi-structured sentences such as manuals to a format compatible with the automatic question answering system. Further, U.S. Patent Application Publication No. 2013/007037 discloses a technology for automatically generating expected questions and answer sentences by extracting existing frequently asked questions (FAQs) in websites or manuals and converting the FAQs to a format compatible with the automatic question answering system. With these techniques, expected questions and answer sentences can easily be generated. However, variations of the generated questions and answers tend to be limited since the sentences in manuals or websites are used.

JP-2021-21990-A discloses a technique for generating a variety of different question sentences by using question sentences input to the automatic answer system by customers themselves. In this technique, when the automatic question answering system correctly answers a question from a customer, the question sentence from the customer at that time is put into the automatic answer system, and the automatic answer system can use the question sentence as an expected question in subsequent answering processing. Thus, the technology disclosed in JP-2021-21990-A is effective in increasing the number of pairs of expected questions and answer sentences. However, only the question sentences that the automatic question answering system has correctly answered are used as expected questions, and answer sentences corresponding to the question sentences that the automatic question answering system has failed to answer are not generated.

### SUMMARY OF THE INVENTION

It is an object of the present invention to provide an automatic question answering system configured to automatically answer a question sentence electronically input by a questioner and automatically create data including pairs of expected questions and answer sentences, the expected questions including question sentences with various expressions that the questioner is likely to ask, with reduced man-hours, and a question-answer pair data generation method.

According to the present invention, there is provided an automatic question answering system including a question-answer pair generation processing unit configured to prepare a question-answer pair in which a question sentence is associated with an answer sentence for automatically giving an answer to the question sentence, a storage device configured to store the question-answer pair including the answer sentence given to a questioner, and a processing device configured to retrieve, from the question-answer pair including the answer sentence given to the questioner, an answer sentence corresponding to a question from the questioner and give the questioner the retrieved answer sentence corresponding to the question. When the questioner (the customer or the like) has a conversation with the automatic question answering system via a chatbot or the like, a history of a series of question sentences and answers from the automatic question answering system (conversation history) is recorded in the system. When the system fails to give a suitable answer in a question-and-answer session with the questioner, the system escalates the question to a support representative. In such a case, the automatic question answering system acquires the contents of a conversation between the support representative and the questioner (question sentence and answer sentence) and generates a new question-answer pair by reusing and combining the acquired question sentence and the answer sentence together. The new question-answer pair is added to question-answer pair data stored in the storage device. Further, the processing device accumulates, in the storage device, a plurality of answer failure question sentences that the questioner has given to the automatic question answering system and that the automatic question answering system has failed to answer, generates a new question-answer pair by reusing the answer failure question sentences later, and adds the new question-answer pair to the question-answer pair data stored in the storage device.

In the automatic question answering system according to the present invention, data including pairs of expected questions and answer sentences, the expected questions including question sentences that a customer is likely to ask, is automatically created and is automatically added to a question-answer pair database, so that an additional question-answer pair can easily be created with reduced man-hours. Further, the question-answer pair database including various expected questions can be created at a low cost. Moreover, as the automatic question answering system to which the present invention is applied operates, more answer sentences of question-answer pairs are accumulated, so that the automatic question answering system can answer more various questions. Accordingly, problems of customers can be resolve more quickly, and customer satisfaction can thus be enhanced. Objects, configurations, and effects other than those described above will be apparent by the following description of modes for carrying out the invention.

### BRIEF DESCRIPTION OF THE DRAWINGS

FIG. 1 is an overall view of a question answering computer 10 according to an embodiment of the present invention;

FIG. 2 is a simplified block diagram of the question answering computer 10;

FIG. 3 is a diagram illustrating an example of question-answer pair data 30 of FIG. 2;

FIG. 4 is a diagram illustrating exemplary entries stored in conversation history data 40 of FIG. 2;

FIG. 5 is a diagram illustrating a support department 500 of FIG. 1;

FIG. 6 is a flowchart illustrating a question-answer pair generation processing procedure performed by the question answering computer 10;

FIG. 7 is a diagram illustrating a configuration example of question-answer pair data 700 including new pairs of question sentences and answer sentences generated by the generation processing of FIG. 6;

FIG. 8 is a flowchart illustrating a question-answer pair generation processing procedure in a second embodiment of the present invention;

FIG. 9 is a simplified block diagram of a customer and equipment operation information management computer 900 in the second embodiment;

FIG. 10 is a diagram illustrating a configuration example of a customer owned equipment table in a third embodiment;

FIG. 11 is a diagram illustrating a configuration example of an equipment operation information table in the third embodiment;

FIG. 12 is a diagram illustrating a configuration example of question-answer pair data in the third embodiment;

FIG. 13 is a flowchart illustrating a question-answer pair generation processing procedure in a fourth embodiment;

FIGS. 14A to 14C are diagrams illustrating an example of generating question-answer pairs in the fourth embodiment;

FIG. 15 is a diagram illustrating exemplary question-answer pair data in a fifth embodiment; and

FIG. 16 is a flowchart illustrating a question-answer pair generation processing procedure in the fifth embodiment.

### DESCRIPTION OF THE PREFERRED EMBODIMENTS

### First Embodiment

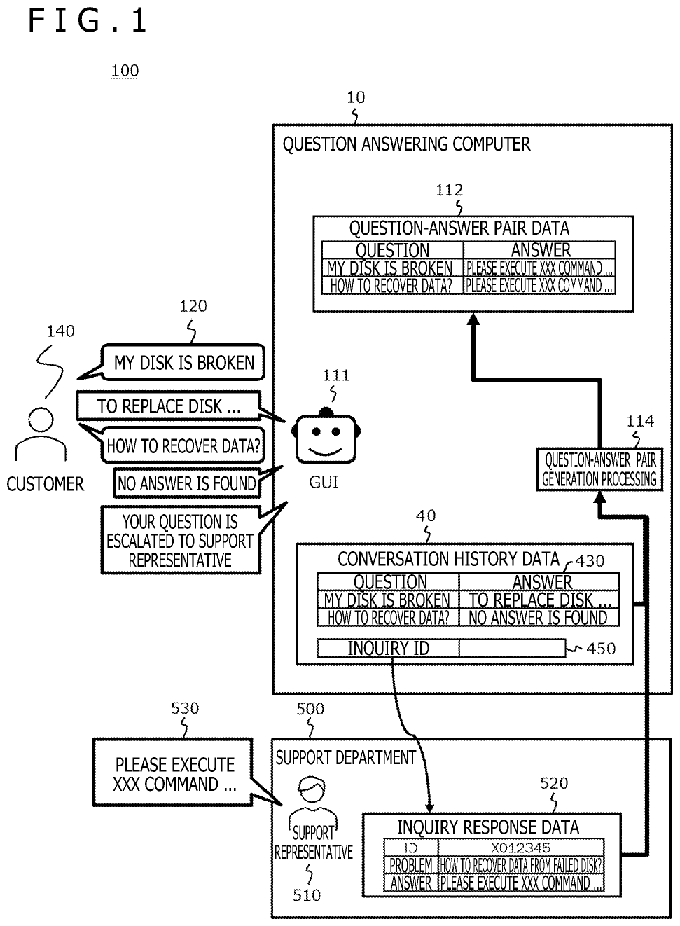

FIG. 1 is an overall view illustrating a question answering computer 10, a customer 140, and a support department 500 according to an embodiment. An automatic question answering system mainly includes the question answering computer 10 that can communicate with the customer 140 via electronic means, and the question answering computer 10 has, for example, a web server function. The customer 140 is a natural person. In the present embodiment, however, a customer is not limited to a natural person, and the present embodiment is also applicable to a case where a customer is computer equipment such as AI. The customer 140 establishes a communication path with the question answering computer 10 via a publicly known information terminal with a communication function, such as a personal computer (hereinafter referred to as a “PC”) or a smartphone. When the customer 140 intends to inquire about something, that is, has a “question,” the customer 140 accesses the question answering computer 10 (for example, a web screen) and interactively exchanges information with the question answering computer 10. In such a manner, the customer 140 asks the question, and the question answering computer 10 answers the question. Here, the customer 140 transmits question sentences and receives answer sentences via a graphical user interface (GUI) 111 provided by the question answering computer 10. In the example of FIG. 1, the customer 140 operates his/her information terminal (not illustrated) to input the first question sentence “my disk is broken” by using a text sentence in a natural language and transmit the question sentence to the question answering computer 10.

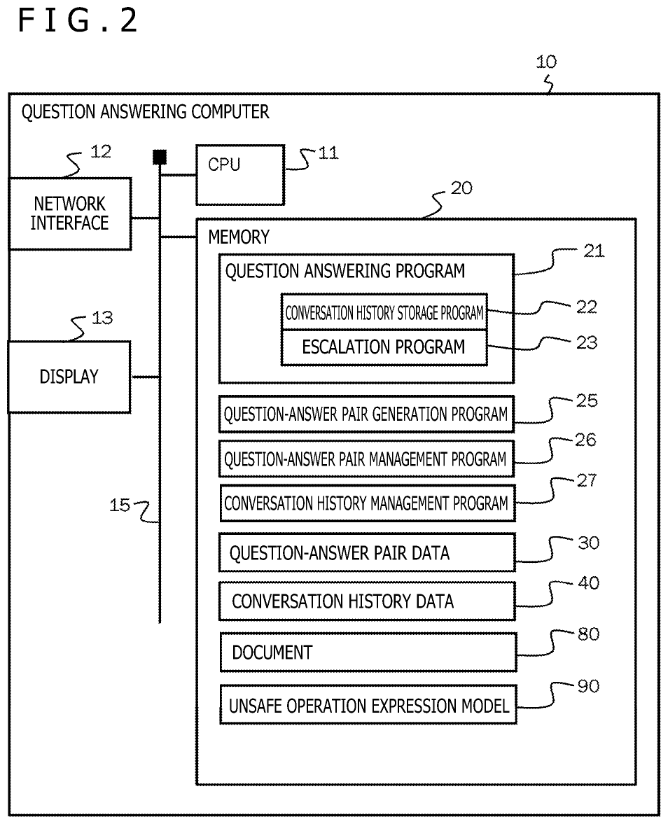

The question answering computer 10 analyzes the received question sentence, selects a corresponding answer sentence (“to replace the disk . . . ”) from a question-answer pair database (question-answer pair data 30 to be described later in FIG. 2) prepared in advance, and transmits the answer sentence to the customer 140 via the GUI 111. In such a conversation as described above, a question sentence and an answer sentence may be exchanged only one time between the customer 140 and the question answering computer 10 in some cases, but are often exchanged a plurality of times as in an example represented by a conversation 120. The whole conversation (question sentences and answer sentences) represented by the conversation 120 is electronically recorded as conversation history data 40 in a memory 20 (described later in FIG. 2) in the question answering computer 10. If the customer 140 is not satisfied with an answer from the question answering computer 10, the customer 140 can escalate the contents of the inquiry to the support department 500 by following instructions from the GUI 111, so that a support representative 510 in the support department 500 can take over the conversation. Upon the escalation, the GUI 111 asks the customer 140 whether or not to escalate the inquiry, and when the customer 140 requires the escalation, the GUI 111 transmits a necessary input form and asks the customer 140 to input necessary information in the input form.

When the inquiry has been escalated, the customer 140 has a conversation with the support representative 510 in the support department 500. The customer 140 can communicate with the support representative 510 through any interactive information exchange means such as a phone call, a chat communication using character input, or e-mail exchanges. The customer 140 obtains, from the support representative 510, an answer sentence 530 related to the contents of the inquiry. Such a conversation between the customer 140 and the support representative 510 is recorded in the support department 500 as inquiry response data 520. As a method of recording a conversation, not only a method of inputting the conversation to a computer by the support representative 510, but also a method of automatically inputting the conversation to the computer or other publicly known methods can be used. The recorded questions and answers are eventually stored as electronic information in a storage device (the hard disk or the like) of a computer (not illustrated) in the support department 500.

When the conversation between the customer 140 and the support representative 510 is complete, the inquiry response data 520 is transmitted from the computer in the support department 500 to the question answering computer 10 via communication means (for example, an internet network). With regard to the timing of this transmission, the inquiry response data 520 may be transmitted to the question answering computer 10 immediately after the inquiry response data 520 is stored in the storage device in the support department 500 or when a load on the computer or network in the support department 500 is light. Alternatively, the inquiry response data 520 may be transmitted at a scheduled time by batch processing.

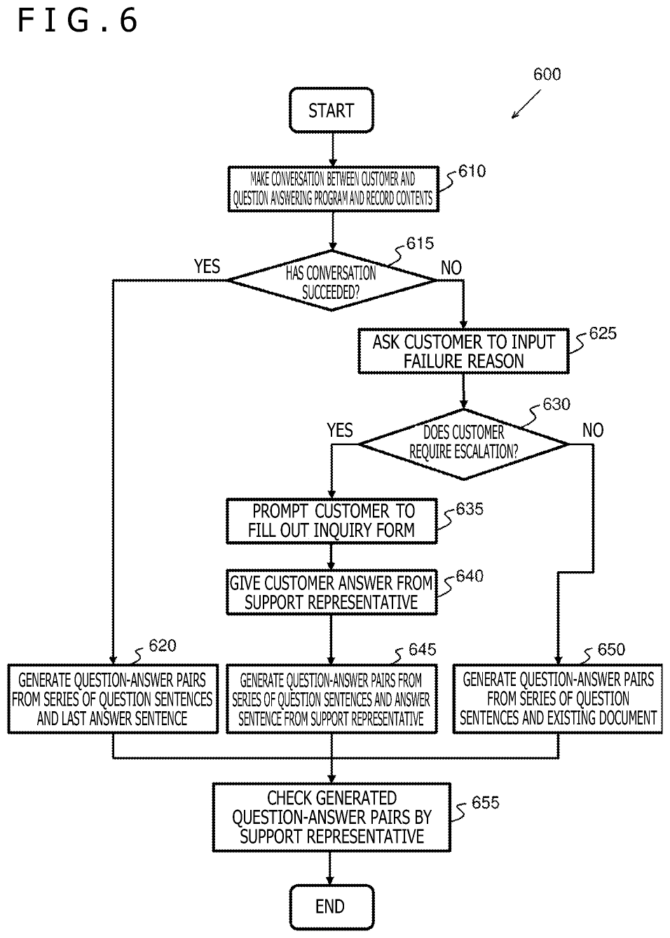

When receiving the inquiry response data 520 from the support department 500, the question answering computer 10 performs processing of generating question-answer pair data (question-answer pair generation processing 114) by using the inquiry response data 520. The details of the question-answer pair data generation processing will be described later in Step 645 of FIG. 6. In the question-answer pair generation processing 114, new question-answer pair data 112 is generated by combining question sentences in the conversation history data 40 with an answer sentence in the inquiry response data 520, and is added to the stored question answering data. In this way, the question-answer pair data 112 including the question sentences input by the customer 140 in the conversation 120 can be created.

Now, individual elements of the automatic question answering system and processing flows are described in detail. FIG. 2 is a simplified configuration diagram of the question answering computer 10. The question answering computer 10 can be implemented by using a general-purpose computer and includes a central processing unit (CPU) 11, the memory 20, a network interface 12, and a display 13. These devices are connected to each other by a data bus 15. The CPU 11 executes a program to perform processing based on the program by using a storage resource (for example, the memory 20), an interface device (for example, the network interface 12), or the like. Note that, instead of the CPU 11 of the question answering computer 10, a controller, a device, a system, a computer, or a node including a processor may mainly execute a program to perform processing.

The CPU 11 executes various programs stored in the memory 20, to execute predetermined processing of the question answering computer 10. An automatic question answering program that the question answering computer 10 executes is a collection of a plurality of programs including a question answering program 21, a question-answer pair generation program 25, a question-answer pair management program 26, and a conversation history management program 27 and is stored in the memory 20 in advance. The memory 20 may store programs other than those exemplified in FIG. 2. The programs (21 to 23 and 25 to 27) can be installed on the question answering computer 10 from a storage medium, which is not illustrated. Further, the programs may be downloaded from a program distribution server or other computers, which are not illustrated, via a network to be installed on the question answering computer 10. In the present embodiment, two or more programs may be implemented as a single program, or a single program (22, 23, 25, 26, or 27) may be implemented as a collection of a plurality of programs. The memory 20 further stores various types of data such as the question-answer pair data 30, the conversation history data 40, a document 80, and an unsafe operation expression model 90.

The question answering program 21 is a program for receiving a question sentence which is input via the GUI 111 and outputting an answer sentence suitable for the received question sentence, and includes a conversation history storage program 22 and an escalation program 23. The conversation history storage program 22 is a program for storing, as the conversation history data 40, the conversation 120 held by the customer 140 via the GUI 111 (see FIG. 1). The escalation program 23 is a program for making a necessary inquiry in escalating a question from the customer 140 to the support department 500. The question-answer pair generation program 25 is a program for generating the question-answer pair data 30 and executes the question-answer pair generation processing 114 of FIG. 1. The question-answer pair management program 26 is a program for managing the question-answer pair data 30 and displays, adds, deletes, or changes a question-answer pair according to an instruction from the support department 500. The conversation history management program 27 is a program for referring to and analyzing the conversation history data 40. The document 80 is a material or data to which the question-answer pair generation program 25 refers when creating the question-answer pair data 30, and has possible answers to a question from the customer 140. Examples of the document 80 include product manuals, catalogs, errata, and frequently asked questions. The unsafe operation expression model 90 stores data that is necessary for the CPU 11 to determine whether or not a specific expression includes expressions that may have adverse effects on the equipment or the customer. Conceivable actual examples of the unsafe operation expression model 90 include a list of words or idioms which are regarded as unsafe expressions, and sentence classification models used for machine learning.

The network interface 12 is used for communication among information equipment (a PC, a smartphone, or the like) owned by a customer, the computer in the support department 500, and other computers inside or outside the company. In communication, a publicly known protocol such as a Transmission Control Protocol/Internet Protocol (TCP/IP), a Hypertext Transfer Protocol (HTTP) constructed on the TCP/IP, or a Secure Shell Protocol (SSH) can be used.

The display 13 is an output device configured to display a screen on which a question-and-answer session is held with the customer 140 and a screen for managing question-answer pair data to the support department 500. Although not illustrated in FIG. 2, a publicly known input device such as a keyboard or a mouse is included to allow an operator who operates the question answering computer to input commands or information. Note that, if another output device that enables a question-and-answer session is provided, the other output device may be substituted for the display 13. For example, if questions and answers are exchanged through a speech, a microphone and a speaker can be substituted for the display 13. Alternatively, the question answering computer 10 itself may not include the display 13 and may exchange questions and answers by transmitting information for giving an instruction on contents of the screen display, such as HyperText Markup Language (HTML), via the network interface 12 and displaying the contents on a display of information equipment of a customer who has received the information.

The programs 21 to 23 and 25 to 27, the data 30 and 40, the document 80, and the unsafe operation expression model 90 which are stored in the memory 20 may not all be included in a single computer (here, the question answering computer 10), and may function in a plurality of computers in a distributed manner. For example, the question answering program 21 and the question-answer pair generation program 25 may be operated on the respective computers different from the question answering computer 10. In this case, the question-answer pair data 30 generated by the other computer is transmitted to a memory (not illustrated) in the computer including the question answering program 21 via the network interface 12. Note that, if other computers are used, a computer including the question-answer pair generation program 25 and the question answering computer 10 are within the scope of the question-answer pair generation system according to the present invention.

The question-answer pair data 30, the conversation history data 40, the document 80, and the unsafe operation expression model 90 may be stored in a location other than the memory 20 as long as they are accessible by the respective programs 21 to 23, 25, 26, and 27. For example, the question-answer pair data 30, the conversation history data 40, the document 80, and the unsafe operation expression model 90 may be stored in a non-volatile storage medium such as a hard disk, a solid-state drive (SSD), or a digital versatile disc (DVD), or may be stored in a database constructed on another computer.

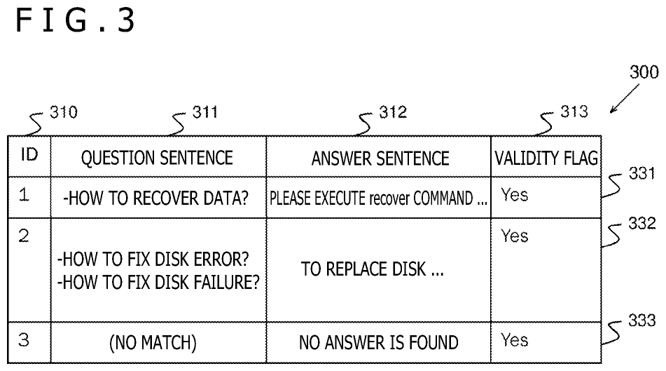

FIG. 3 illustrates a configuration example of a piece of question-answer pair data 300 stored in the question-answer pair data 30 in the memory 20. In the example of FIG. 3, question sentences 311, answer sentences 312, and validity flags 313 are related to a disk device that is a product owned by the customer 140. It is assumed in this example that questions and answers are exchanged between a customer who needs to recover data stored in the disk device and a product developing company. The question sentences 311 include questions implying that the stored data has an error or has been corrupted and that some measures are needed. As answers to the question sentences 311 input by the customer 140, the answer sentences 312 which the question answering program 21 has retrieved and extracted from the question-answer pair data 30 are listed. The validity flag 313 stores a boolean value indicating whether or not the entry in question is to be used by the question answering program 21 as an answer. The question-answer pair data 300 has a table format in which a plurality of correspondences between the question sentences 311 and the answer sentences 312 and a plurality of validity flags 313 are listed, and each question-answer pair (each row) is given a corresponding number (1, 2, 3, . . . ) as an identification (ID) 310. Here, in the question-answer pair data 300, three question-answer pairs, namely, entries 331, 332, and 333, are registered, and numbers 1, 2, and 3 are allocated thereto as the IDs. Note that a plurality of question sentences 311 may be included in a single entry. For example, in the entry 332, two question sentences 311 having substantially the same meaning are stored.

When receiving a question sentence input from the customer 140 in a chat using the GUI 111, the question answering program 21 searches the entries 331 to 333 and the like included in a plurality of pieces of the question-answer pair data 300 stored in the question-answer pair data 30 in the memory 20 for an entry close to the question sentence input by the customer. Here, if an entry including a question sentence which is close to the question sentence from the customer is found from among the entries to which the validity flags 313 are set, the question answering program 21 outputs the answer sentence 312 in the entry as an answer for the chat.

The question answering program 21 can determine how close a question sentence input by the customer and the question sentence 311 are, according to various natural language processing technologies used for language processing. For example, a method of calculating the probability of co-occurrence of the same word in the both sentences, a bilingual evaluation understudy (BLEU) value, or a distance between vectors in distributed representations of words is applicable.

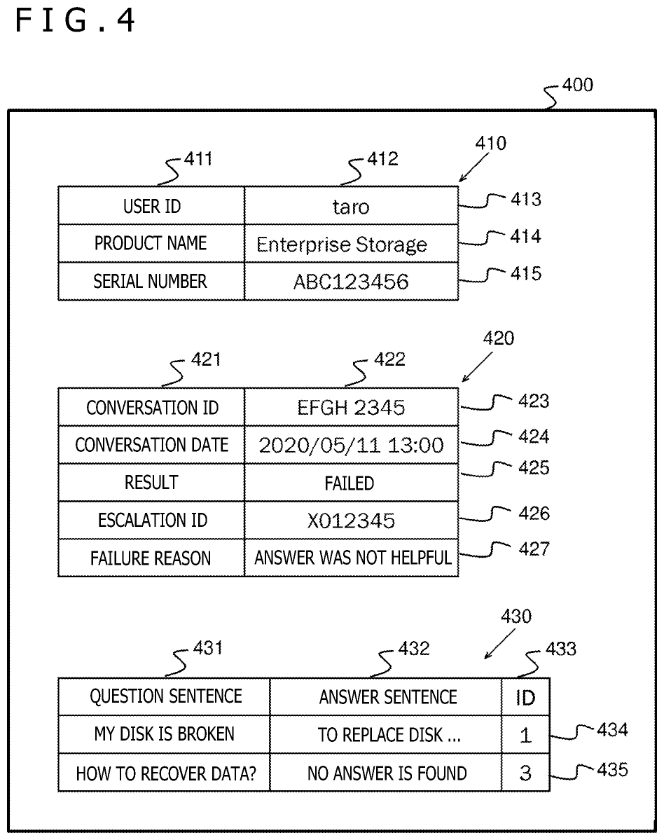

FIG. 4 illustrates a configuration example of a conversation history 400 included in the conversation history data 40. A history is generated every time a conversation takes place, as in the conversation history 400 illustrated in FIG. 4, and a plurality of histories are stored in the conversation history data 40 in the memory 20. The conversation history 400 includes user information 410, a conversation summary 420, and conversation details 430. In the user information 410, information regarding the customer 140 who makes an inquiry is stored, and a plurality of pairs of items 411 and values 412 are listed. In an entry 413, a “user ID” is stored as the item 411, and “taro” is stored as the value 412. “taro” is a character string uniquely identifying the customer 140 and is a name here. In an entry 414, a “product name” is stored as the item 411, and a product name “Enterprise Storage” is stored as the value 412. In an entry 415, a “serial number” is stored as the item 411, and identification information “ABC123456” regarding the product about which the customer “taro” has inquired is stored as the value 412.

In the conversation summary 420, pieces of information regarding the conversation 120 (see FIG. 1), which represents the conversation between the customer 140 and the GUI 111, and excluding information regarding the question sentences and the answer sentences are stored. In the conversation summary 420, a plurality of pairs of items 421 and values 422 are listed. In an entry 423, a “conversation ID” which is a character string uniquely identifying the conversation history 400 is stored as the item 421, and the value of an identification code is stored as the value 422. In an entry 424, a “conversation date” is stored as the item 421, and the date and time at which the conversation has been held is stored as the value 422. An entry 425 is a field in which a result of a determination made by the customer on whether a problem about which the customer has inquired is resolved through the conversation is stored. In the entry 425, a “result” is stored as the item 421, and “failed” is stored as the value 422. In an entry 426, an “escalation ID” is stored as the item 421. When the question is escalated to the support department 500 after the conversation between the GUI 111 and the customer 140 as illustrated in FIG. 1, an ID is allocated in association with the contents of the escalation, and the ID is stored as the value 422. Note that, when no escalation is performed, the value 422 in the entry 426 is empty, that is, no data is stored. In an entry 427, a “failure reason” is stored as the item 421. In addition, “the answer was not helpful” which has been input by the customer 140 and which is the reason why the customer 140 considers that the question answering program 21 has failed to answer is stored as the value 422.

The conversation details 430 include question sentences 431 input by the customer 140, answer sentences 432 used (selected and extracted from the question-answer pair data 300) by the question answering program 21 as answers, and IDs 433 allocated to the respective answer sentences 432. When a question and an answer are exchanged with the customer 140 a plurality of times, the number of entries increases like entries 434, 435, . . . , in the conversation details 430 every time a question and an answer is exchanged. The exemplary data stored in the conversation history data 40 in the memory 20 as the conversation history 400 has been described above. In the example of the conversation illustrated in FIG. 4, one conversation result “failed” is stored in the entry 425, and one failure reason “the answer was not helpful” is stored in the entry 427. However, columns may be added to the conversation details 430, and a result and a failure reason may be described in the columns for each of the entries.

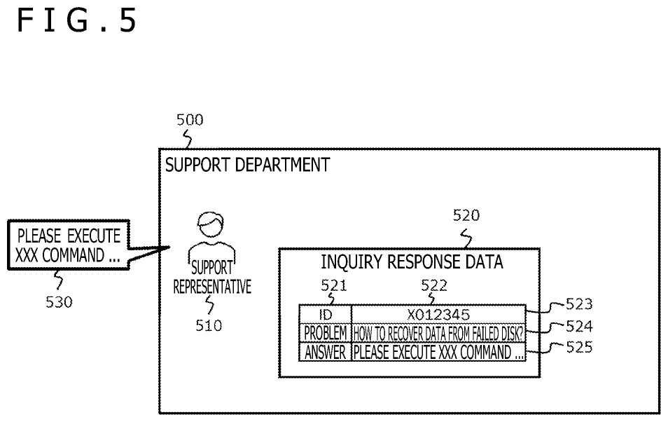

FIG. 5 illustrates a configuration example of the support department 500. FIG. 5 corresponds to the lower part of FIG. 1 and has the same reference signs as FIG. 1. The support department 500 is a department for answering an inquiry from the customer 140 (see FIG. 1) to resolve the problem, for example. The support department 500 usually includes a computer (not illustrated) different from the question answering computer 10 mainly included in the automatic question answering system, and a plurality of pieces of inquiry response data 520 regarding inquiries from the customer 140 are recorded in the computer in the support department 500. Further, new inquiry response data 520 is created every time the customer 140 makes an inquiry. FIG. 5 exemplifies data (inquiry response data 520) corresponding to only a single inquiry.

To the support department 500, the support representative 510 who answers questions from the customer 140 belongs. A person with the ability to resolve problems related to equipment sold by the company is generally assigned to the support representative 510. However, the support representative 510 may not be a human and may be, for example, software or a robot that has the ability to resolve problems and that can answer inquiries. The support representative 510 exchanges questions and answers with the customer 140 by using existing communication means such as a face-to-face conversation, e-mail, or a phone call, thereby eventually presenting the answer sentence 530 that resolves the problem to the customer 140. Then, the support representative 510 finishes answering the inquiry. At that time, the conversation between the customer 140 and the support representative 510 is recorded as the inquiry response data 520. As long as the question-answer pair generation program 25 of the question answering computer 10 can refer to the record of the inquiry response data 520, the inquiry response data 520 may be stored in a database constructed on the computer of the support representative 510 or a server or may be stored in another electronic recording medium or a paper medium. For example, when a conversation has been held with the customer 140 by a chat or e-mail, it is sufficient if the exchanged text sentences are automatically stored in the memory of the computer (not illustrated) in the support department. When a conversation has been held with the customer 140 over the phone, it is sufficient if the support representative 510 inputs the record of the conversation to the computer (not illustrated) in the support department to create the inquiry response data 520.

The inquiry response data 520 has a format in which item names 521 and values 522 are listed. In an entry 523, an “ID” is stored as the item name 521, and its ID is stored as the value 522. The value 522 stored in the entry 523 is a character string uniquely identifying the inquiry response data 520, and the value 422 for the escalation ID in the entry 426 in the conversation history 400 illustrated in FIG. 4 is an ID that is stored as the value 522 in the entry 523 in the corresponding inquiry response data 520. In an entry 524, a “problem” is stored as the item name 521, and a question about which the customer 140 has inquired is stored as the value 522.

In an entry 525, an “answer” is stored as the item name 521, and an answer sentence “please execute the XXX command . . . ” that has been given to the customer eventually is stored as the value 522. The inquiry response data 520 may include more various items. For example, information regarding other conversations held between the customer 140 and the support representative 510, a process of resolving a problem, or equipment owned by the customer at the time of the occurrence of the problem may be stored.

FIG. 6 is a flowchart illustrating a question-answer pair generation processing procedure. The procedure indicated by a question-answer pair generation processing flow 600 is mainly implemented by the CPU 11 (see FIG. 2) executing the question answering program 21, the question-answer pair generation program 25, the question-answer pair management program 26, and the conversation history management program 27 which are stored in the memory 20 of the question answering computer 10 (see FIG. 2). First, the CPU 11 starts a conversation with the customer 140 by using the GUI 111 (see FIG. 1). The contents of questions and answers exchanged with the customer 140 is recorded in the conversation history data 40 in the memory 20 by the question-answer pair generation program 25 (Step 610). Next, the CPU 11 executes the conversation history storage program 22 included in the question answering program 21, to create the conversation history 400. When a question and an answer are exchanged a plurality of times, as many entries as the questions and the answers are exchanged are added to the conversation details 430 (see FIG. 4). When the question-and-answer session ends, the question answering program 21 uses the GUI 111 to transmit a question sentence to the customer 140 to ask whether the conversation has succeeded, that is, whether the problem about which the customer 140 has inquired is resolved. After receiving an answer from the customer 140, the question answering program 21 determines whether the conversation has “succeeded,” that is, the customer 140 obtains an appropriate answer, or the conversation has “failed,” that is, the customer 140 does not obtain an appropriate answer (Step 615).

In a case where the customer 140 answers in Step 615 that “the conversation has succeeded,” the question-answer pair generation program 25 creates entries in the question-answer pair data 300 (see FIG. 3). Here, a series of question sentences is recorded in the conversation details 430, and the respective question sentences are denoted by X1, X2, . . . , and Xn. In addition, answer sentences that correspond to the question sentences X1, X2, . . . , and Xn are denoted by Y1, Y2, . . . , and Yn, respectively. Moreover, IDs that correspond to the question sentences X1, X2, . . . , and Xn are denoted by Z1, Z2, . . . , and Zn, respectively. When the customer 140 answers that the conversation has succeeded, it can be said that the answer sentence Yn corresponding to the last question sentence Xn is appropriate. At this time, the question-answer pair generation program 25 combines the question sentences X1, . . . , and Xn with the last answer sentence Yn, that is, combines question sentences with answer sentences to make pairs (X1, Yn), (X2, Yn), . . . , and (Xn, Yn). Thus, the question-answer pair generation program 25 newly creates n question-answer pairs (Step 620). Alternatively, the question-answer pair generation program 25 may add, instead of creating n question-answer pairs, all the question sentences X1, . . . , and Xn to an entry corresponding to the ID Zn in the existing question-answer pair data 300 as the question sentences 311 (Step 620). In any case, the question-answer pair(s) can be generated such that the question sentences X1, . . . , and Xn are stored as the question sentences 311 illustrated in FIG. 3 and the answer sentence Yn is stored as the answer sentence 312.

In a case where the customer 140 answers in Step 615 that the conversation has failed, the question answering program 21 asks, via the GUI 111, the customer 140 a question, i.e., the reason why the customer 140 has determined that the conversation has failed. The customer 140 inputs a failure reason (Step 625), and the failure reason is stored as the value 422 in the entry 427 in the conversation history 400 illustrated in FIG. 4. Subsequently, the question answering program 21 asks, via the GUI 111, the customer 140 whether or not to escalate the inquiry to the support department 500 (Step 630). Here, when the customer 140 requires the escalation, the CPU 11 displays an inquiry form on the customer's information terminal by executing the escalation program 23 and prompts the customer 140 to input the contents of the inquiry (Step 635).

When the customer 140 inputs necessary information to the form by using his/her information terminal, the information is transmitted from the information terminal of the customer 140 to the question answering computer 10. The escalation program 23 records the received contents as the inquiry response data 520 (see FIG. 5), and the conversation between the customer 140, and the question answering program 21 and the escalation program 23 is complete. At this point, not all entries 524 and 525 in the inquiry response data 520 may be filled out. In particular, the entry 525 (answer) illustrated in FIG. 5 is an item in which the support representative 510 inputs information later, and hence, there is no need for the customer 140 to fill out the entry 525. After that, the support representative 510 refers to the recorded inquiry response data 520 to answer the inquiry from the customer (Step 640). In answering the inquiry, in the support department, an answer sentence Z given to the customer is electronically recorded as the value 522 in the entry 525 in the inquiry response data 520.

Next, with the use of the conversation history 400 (see FIG. 4) and the contents of the answer (the value 522 in the entry 525) stored in the inquiry response data 520 (see FIG. 5), the question-answer pair generation program 25 combines the question sentences X1, . . . , and Xn with the answer sentence Z that is given to the customer and that is included in the inquiry response data matching the value 422 for the escalation ID in the entry 426. In such a manner, the question-answer pair generation program 25 combines question sentences with answer sentences to make pairs (X1, Z), (X2, Z), . . . , and (Xn, Z), and thus newly creates n question-answer pairs (Step 645). Alternatively, the question-answer pair generation program 25 may newly create, instead of creating n question-answer pairs, a single question-answer pair such that all the question sentences X1, . . . , and Xn are stored as the question sentences 311 and only the answer sentence Z is stored as the answer sentence 312. In any case, the question-answer pair(s) can be generated such that the question sentences X1, . . . , and Xn are stored as the question sentences 311 and the answer sentence Z is stored as the answer sentence 312.

Here, the question-answer pair generation procedure in Step 645 is further described. In generating a question-answer pair, the question sentence 311 and the answer sentence 312 illustrated in FIG. 3 may be processed to create different sentences. Examples of the processing include changing postpositional particles to make question sentences more natural, mutually converting interrogative sentences and declarative sentences, mutually converting kanji and kana, changing the tenses or conjugations of words, replacing words with synonyms, and deleting personal information or confidential information included in question sentences. These types of processing are also applicable to Steps 620 and 650. In order to create different sentences through the processing, the CPU 11 executes the question-answer pair generation program 25 illustrated in FIG. 2. The question-answer pair generation program 25 operates as follows.

(1) First, the question-answer pair generation program 25 formats and processes the question sentences X1, . . . , and Xn to create processed question sentences X′1, . . . , and X′m. Examples of the formatting and the processing include correcting typographical errors, changing word orders, mutually converting interrogative sentences and declarative sentences, mutually converting kanji and kana, changing the tenses or conjugations of words, replacing words with synonyms, and deleting confidential information (such as a questioner's name, an operating environment, or an equipment name) in the question sentences 311. Through the formatting and the processing, a plurality of question sentences may be generated from a single question sentence, or a question sentence may be deleted, in contrast, if the question sentence includes confidential information, for example. Thus, the number of question sentences may be changed before and after processing.

(2) Next, the question-answer pair generation program 25 formats and processes an answer sentence V (corresponding to the answer sentence Yn in Step 620, the answer sentence Z in Step 645, or a sentence W in Step 650) to generate a processed answer sentence V′. Examples of the formatting and the processing include, as in the procedure (1) described above, correcting typographical errors, changing word orders, mutually converting kanji and kana, changing the tenses or conjugations of words, replacing words with synonyms, and deleting confidential information (such as a questioner's name, an operating environment, or an equipment name) in the answer sentence 312. Further, words and phrases in the answer sentence V′ that indicate unsafe operations may be deleted with the technique described in Japanese Patent Application No. 2021-093934, which is an earlier application of the present applicant, for example. When an answer sentence is inappropriate (when the answer sentence does not have enough information or still has confidential information or unsafe operations), the answer sentence may be deleted. When such an answer sentence is deleted, a question-answer pair including a question sentence corresponding to the deleted answer sentence is not created.

(3) Next, the question-answer pair generation program 25 combines the processed question sentences X′1, . . . , and X′m with the processed answer sentence V′ to newly create m question-answer pairs such as pairs (X′1, V′), (X′2, V′), . . . , and (X′m, V′). Alternatively, the question-answer pair generation program 25 may add, instead of creating m question-answer pairs, all the processed question sentences X′1, . . . , and X′m to the entry corresponding to the ID Zn in the existing question-answer pair data 300 as the question sentences 311. In any case, the question-answer pair(s) can be generated such that the processed question sentences X′1, . . . , and X′m are stored as the question sentences 311 and the processed answer sentence V′ is stored as the answer sentence 312.

In generating a question-answer pair in Step 620, 645, or 650 by the procedures (1) to (3) described above, the question sentence 311 and the answer sentence 312 may be processed to create different sentences.

Next, the question-answer pairs generated by the support representative 510 and normalized by the question-answer pair generation program 25 are examined and checked by a person in charge of question-answer pair data check (Step 655). Then, a question-answer pair that is determined to have an inappropriate correspondence between the question sentence 311 and the answer sentence 312 is deleted or given a validity flag by the support representative 510, thereby preventing the question answering program 21 from using the inappropriate question-answer pair as an answer. Step 655 may not be performed. When Step 655 is performed, inappropriate question-answer pairs are removed manually, so that high-quality question-answer pairs can remain. When Step 655 is not performed, on the other hand, the quantity of manual operation is reduced, so that question-answer pairs can be created with reduced man-hours.

In a case where the customer 140 answers in Step 630 that the customer 140 does not require the escalation, in the chat using the GUI 111, the conversation between the customer 140 and the question answering program 21 ends. The question answering program 21 searches the conversation history recorded in the conversation history data 40 (see FIG. 2) and the document 80 stored in the memory 20 illustrated in FIG. 2 for a description similar to the contents of the question sentences X1, . . . , and Xn in the conversation history 400 (Step 650). As a method of searching for a similar description, an existing method including the quantitative comparison of the similarity between sentences, such as a method of calculating the number of common words or a method using a distance between distributed representations of words or sentences, can be used. When a sentence W having a similarity equal to or greater than a certain level is found, the question-answer pair generation program 25 combines the question sentences X1, . . . , and Xn with the sentence W that is given to the customer. In such a manner, the question-answer pair generation program 25 combines question sentences and answer sentences to make pairs (X1, W), (X2, W), . . . , and (Xn, W), and thus newly creates n question-answer pairs (Step 650). Alternatively, the question-answer pair generation program 25 may newly create, instead of creating n question-answer pairs, a single question-answer pair such that all the question sentences X1, . . . , and Xn are stored as the question sentences 311 and only the sentence W is stored as the answer sentence 312. In any case, the question-answer pair(s) can be generated such that the question sentences X1, . . . , and Xn are stored as the question sentences 311 and the sentence W is stored as the answer sentence 312. After that, Step 655 is executed.

As described above, the new question-answer pairs are generated by the procedure illustrated in the flowchart of FIG. 6. Step 620, 645, or 650 in the procedure may be executed on a real time basis when a pair of a question sentence and an answer sentence is acquired, or may be executed at scheduled times, fixed intervals, or the like by batch processing.

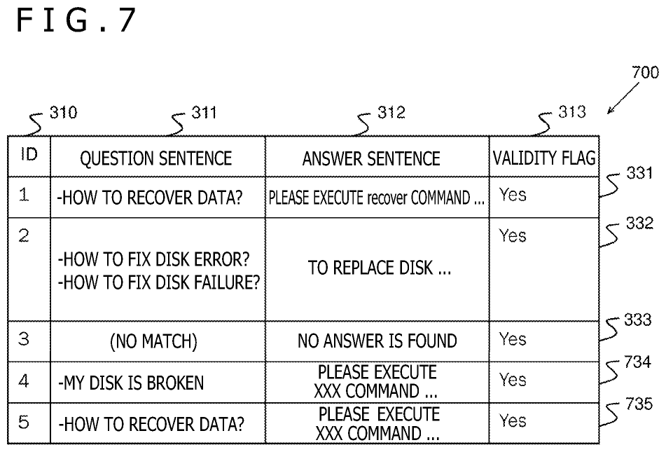

Next, with reference to FIG. 7, a configuration example of question-answer pair data 700 including question-answer pairs generated by the question-answer pair generation program 25 will be described. The question-answer pair data 700 includes, in addition to the respective entries 331 to 333 in the question-answer pair data 300 illustrated in FIG. 3, new entries 734 and 735 corresponding to the question-answer pairs generated in Step 645. The entries 734 and 735 are created as a result of the execution of Step 645 of FIG. 6. In the entries 434 and 435 in the conversation details 430 illustrated in FIG. 4, the question sentences “my disk is broken” and “how to recover data?” are included. Further, in the entry 525 in the inquiry response data 520 illustrated in FIG. 5, an answer sentence “please execute the XXX command . . . ” is included. Thus, by combining these, the question-answer pair generation program 25 generates the new entries 734 and 735 and the contents as the question sentences 311 and the answer sentences 312 in the entries 734 and 735.

As described above, according to the first embodiment of the present invention, various question sentences that the customer 140 has input to the automatic question answering system (question answering computer 10) via a chatbot are combined with the same answer sentence, so that question-answer pairs can be generated with reduced man-hours. The customer 140 obtains the desired answer through trial and error. Until the desired answer is obtained, the customer 140 inputs question sentences to the question answering computer 10 and gives question sentences to the support representative 510. Hence, it can be said that the resulting question sentences express the same question in various ways. Therefore, question-answer pairs are created by associating a plurality of question sentences with the same answer sentence. This makes it possible for the automatic question answering system to deal with various expressions in the future, and is thus effective. Further, the answer accuracy of the automatic question answering system is enhanced, and the time required to resolve a question is shortened. Accordingly, the waste of electricity, the waste of human resources, and the like can be avoided. As a result, the energy-efficient and environmentally friendly automatic question answering system can be implemented.

### Second Embodiment

Next, a second embodiment of the present invention will be described. In the first embodiment, an answer sentence is associated with a series of question sentences input by a single customer, with the customer ID serving as a key, to automatically generate question-answer pairs. However, in the procedure of the first embodiment illustrated in FIG. 6, since inappropriate question-answer pairs may be deleted in Step 655, question sentences associated with no answer sentence may possibly remain. In the second embodiment, such a question sentence that has associated with no answer sentence in the past is newly associated with an answer sentence by use of a subsequent question answering case example (a successful example, in particular), to create a new question-answer pair.

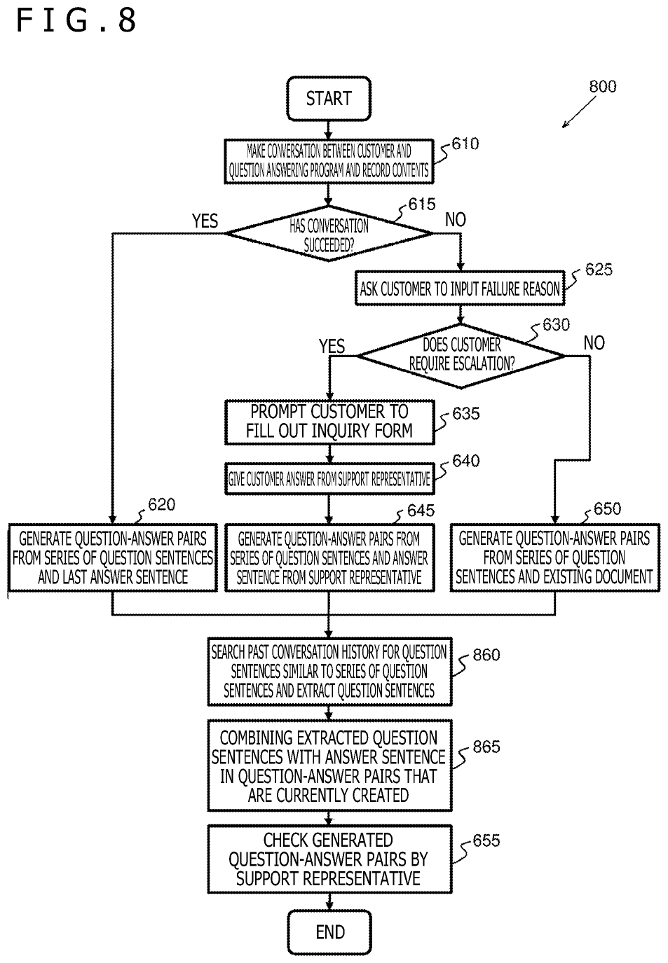

FIG. 8 is a flowchart illustrating a question-answer pair generation processing procedure in the second embodiment. A question-answer pair generation processing flow 800 includes the same steps as those in the question-answer pair generation processing flow 600 illustrated in FIG. 6, except that Steps 860 and 865 are added before Step 655. The steps common to the flowcharts of FIG. 6 and FIG. 8 are denoted by the same reference signs, and a repetitive description is omitted. Here, only Steps 860 and 865, which are additionally included in the flowchart of FIG. 8, are described.

In Step 860, the question-answer pair generation program 25 (see FIG. 2) performs the following processing. Specifically, the question-answer pair generation program 25 refers to the question sentences 431 (see FIG. 4) in the conversation history data 40 via the conversation history management program 27 (see FIG. 2) and searches for question sentences V1, . . . , and Vn which are obtained from the past conversations and which are similar to the question sentences X1, . . . , and Xn in the conversation history recorded in Step 610. Similar question sentences tend to have many common words. Further, similar question sentences can be detected on the basis of any criteria such as whether the question sentences have similar topics, for example. As the similar question sentences, not only past question sentences from the same questioner but also past question sentences from others can be used.

Next, the question-answer pair generation program 25 checks the question sentences V1, . . . , and Vn against the question-answer pair data 300, removes, from among the question sentences V1, . . . , and Vn, question sentences included in the question-answer pair data 300, and sets the remaining question sentences to S1, . . . , and Sm. Supposing that an answer sentence of the question-answer pairs generated in any of Steps 620, 645, and 650 is denoted by T, m new question-answer pairs are created in Step 865 such that question sentences are combined with answer sentences to make pairs (S1, T), (S2, T), . . . , and (Sm, T) (Step 865). Alternatively, the question-answer pair generation program 25 may newly create, instead of creating m question-answer pairs, a single question-answer pair such that all the question sentences S1, . . . , and Sm are stored as the question sentences 311 and only the answer sentence T is stored as the answer sentence 312. In any case, the question-answer pair(s) can be generated such that the question sentences S1, . . . , and Sm are stored as the question sentences 311 and the answer sentence T is stored as the answer sentence 312. The generated question-answer pairs are examined and checked by the person in charge of question-answer pair data check (Step 655). Then, a question-answer pair that is determined to have an inappropriate correspondence between the question sentence 311 and the answer sentence 312 is deleted by the support representative 510.

According to the second embodiment, while question-answer pairs are generated by the procedure of the first embodiment, with the use of question sentences and answer sentence that are used at the time of the generation of the question-answer pairs, question sentences about which the customer has inquired in the past can be retroactively combined with the current answer sentence to thereby generate question-answer pairs. By use of past inquiries, new question-answer pairs may be generated on a real time basis or by batch processing.

### Third Embodiment

In the first and second embodiments, as expected questions of question-answer pairs to be created, only question sentences input by the customer 140 are used. Thus, an answer is often given to the customer 140 without identifying product information regarding a product that has already been bought and operated by the customer 140. In a third embodiment, when the customer 140 who has already bought and operated the product has a conversation with the question answering program 21, more detailed question-answer pairs are generated by using operation information regarding the product. A product-providing company sometimes holds operation information regarding the equipment used by the customer 140 in order to provide customer support. In such a case, the operation information can be used to generate question-answer pairs.

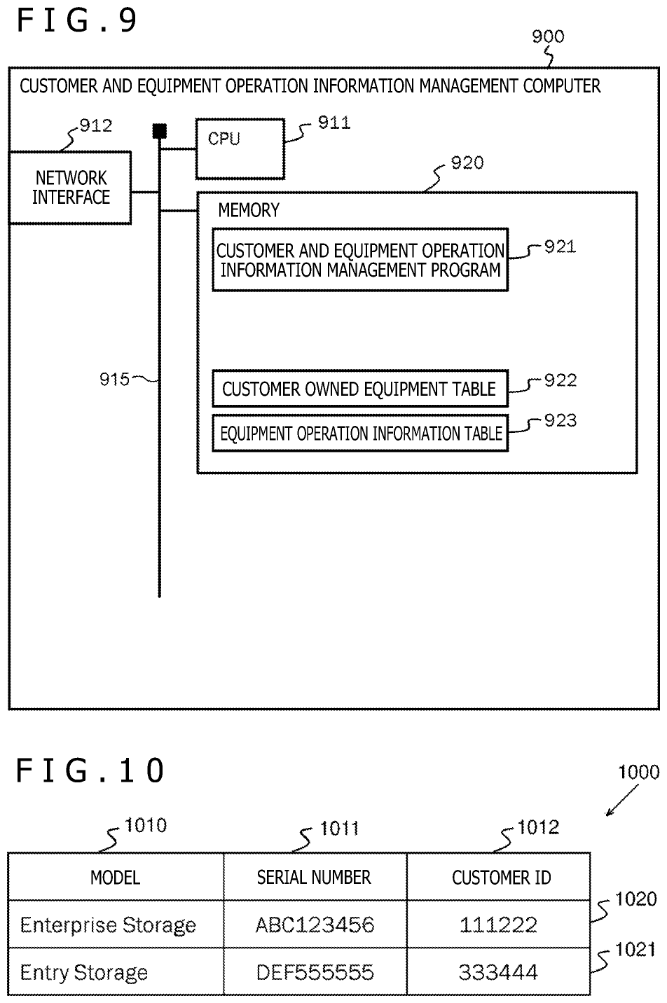

FIG. 9 is a configuration diagram of a customer and equipment operation information management computer 900. The customer and equipment operation information management computer 900 includes a CPU 911, a memory 920, and a network interface 912. The customer and equipment operation information management computer 900 may be implemented by, for example, a computer in a data center of the company. These functions may be implemented by the question answering computer 10, or may be implemented by a dedicated independent computer near the question answering computer 10. Further, the question answering computer 10 and the customer and equipment operation information management computer 900 may not be installed at the same place, and may be installed at separate locations. The CPU 911 and the network interface 912 operate similarly to those in the question answering computer 10. The CPU 911 executes a program to perform processing based on the program by using a storage resource (for example, the memory 920), an interface device (for example, the network interface 912), or the like that are connected to the CPU 911 by a data bus 915.

The memory 920 stores a customer and equipment operation information management program 921, a customer owned equipment table 922, and an equipment operation information table 923. The customer and equipment operation information management program 921 is a program for referring to and updating the contents in the customer owned equipment table 922 and the equipment operation information table 923 according to instructions from an external computer via the network interface 912. The customer owned equipment table 922 holds information regarding equipment owned by each customer. The equipment operation information table 923 holds information indicating the operating status of the equipment owned by each customer. The customer owned equipment table 922 is generally updated infrequently and is updated only when the customer introduces or discards the equipment, in many cases. In contrast, the equipment operation information table 923 is frequently updated with operation information regularly collected from the operating equipment via a network.

The customer owned equipment table 922 may be filled out by the customer 140 himself/herself via a web screen, which is not illustrated, provided by the customer and equipment operation information management computer 900, or may be filled out by the support representative 510 with information acquired from the customer 140. The customer and equipment operation information management computer 900 may communicate, when the customer initially sets up the equipment, with the equipment via the network interface 12 to automatically acquire information from the customer's equipment. The equipment operation information table 923 is preferably regularly updated by the customer and equipment operation information management computer 900 communicating with the customer's equipment via the network interface 12.

FIG. 10 illustrates a configuration example 1000 of data stored in the customer owned equipment table 922. The customer owned equipment table configuration example 1000 is a table including three columns for models 1010, serial numbers 1011, and customer IDs 1012 and stores a plurality of entries 1020 and 1021. Each of the entries 1020, 1021, etc., corresponds to a single piece of equipment owned by a customer. The model of the equipment is stored as the model 1010, and the serial number of the equipment is stored as the serial number 1011. As the customer ID 1012, an identifier identifying the customer 140 who is the owner of the model 1010 is stored. Since each entry corresponds to a single model 1010, the serial numbers 1011 are required to be unique to the respective entries. The models 1010 and the customer IDs 1012 may be the same between the plurality of entries. Note that the customer owned equipment table configuration example 1000 may hold information other than the examples of FIG. 10. For example, columns for new information corresponding to configuration information regarding equipment, accessories, information regarding customers themselves, or the like may further be added.

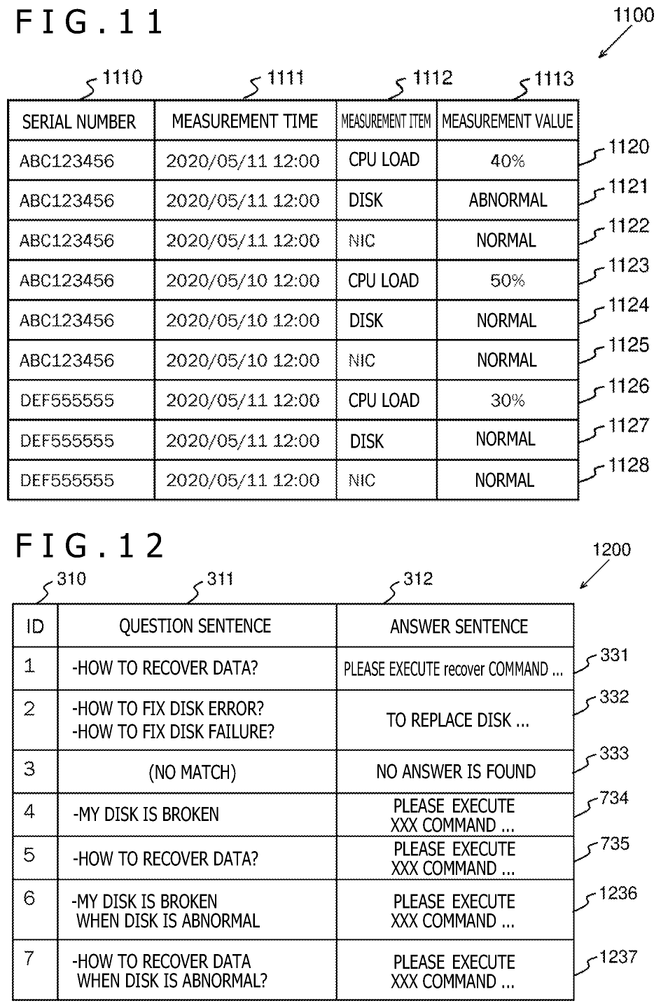

FIG. 11 is a configuration example of an equipment operation information table 1100. The equipment operation information table 1100 is a table including four columns for serial numbers 1110, measurement times 1111, measurement items 1112, and measurement values 1113 and stores a plurality of entries 1120 to 1128. Each entry corresponds to a single piece of equipment, a single time, and a single measurement item. The serial number 1110 is a number identifying the corresponding equipment and is associated with the serial number 1011 in the customer owned equipment table configuration example 1000. The measurement time 1111 indicates the time at which a measurement value in an entry is measured. The measurement item 1112 and the measurement value 1113 indicate a measurable item of a product and a measurement value thereof. The measurement value 1113 can take various entry-based formats. For example, in the entry 1120, since the measurement item 1112 indicates a “CPU load,” the measurement value 1113 is described in percentage. In the entries 1121 and 1122, binaries indicating whether the operation of the equipment is “normal” or “abnormal” are stored as the measurement values 1113.

Although the equipment operation information is independently provided as the equipment operation information tables 923 and 1100 in FIG. 9 and FIG. 11, the equipment operation information may be stored in a computer different from the customer and equipment operation information management computer 900. For example, a measurement item and a measurement value at a time point corresponding to the conversation date in the entry 424 may additionally be stored in the conversation history data 40 illustrated in FIG. 2.

In the third embodiment, in Step 620, 645, or 650, in which question-answer pairs are generated in the question-answer pair generation processing flow 600 illustrated in FIG. 6, the CPU 11 generates question sentences on the basis of the contents in the equipment operation information table 1100. On the basis of the serial number described in the entry 415 and the conversation date described in the entry 424 in the conversation history 400 illustrated in FIG. 4, the question-answer pair generation program 25 (see FIG. 2) refers to the equipment operation information table 1100 to thereby refer to an entry having the matching serial number 1110 and the measurement time 1111 that is the closest to the conversation date in the entry 424 (see FIG. 4). For example, if the serial number in the entry 415 is “ABC123456” and the conversation date in the entry 424 is “2020/05/11 13:00,” the entries 1120, 1121, and 1122 in the equipment operation information table 1100 of FIG. 11 are the corresponding entries.

The question-answer pair generation program 25 identifies, from the entries 1120, 1121, and 1122 obtained in this way, a problematic entry, that is, an entry having the measurement value 1113 equal to or greater than a threshold or indicating a “abnormal” state. Here, among the entries 1120, 1121, and 1122, the entry 1121 indicating a “abnormal” state as the measurement value 1113 is the corresponding entry. In that case, the CPU 11 can generate a question sentence by incorporating the measurement item 1112 and the measurement value 1113 in the entry 1121 in the question sentence.

FIG. 12 illustrates a configuration example of question-answer pair data 1200 created by a procedure according to the present embodiment. The question-answer pair data 1200 includes, in addition to the question-answer pair data 700 illustrated in FIG. 7, new entries 1236 and 1237 created by a procedure unique to the third embodiment. As described above, at the time of the execution of the conversation with the customer 140, which is indicated by the conversation history 400 illustrated in FIG. 4, the disk used by the customer 140 is abnormal as indicated by the entry 1121 illustrated in FIG. 11. Thus, the entries 1236 and 1237 illustrated in FIG. 12 have question sentences obtained by adding a phrase “when the disk is abnormal” to the question sentences in the entries 734 and 735.

Note that, in incorporating the measurement item 1112 and the measurement value 1113 in an entry illustrated in FIG. 11 to the question-answer pair data 1200, the sentence may be rewritten to a more natural question sentence. For example, each of the question sentences 311 in the entries 1236 and 1237 includes a phrase “when the disk is abnormal.” This phrase is obtained by adding the words “when,” “the,” and “is” to the word “disk” in the measurement item 1112 and the word “abnormal” in the measurement value 1113 in the entry 1121 of FIG. 11. In this way, postpositional particles or words may be added, or words may be conjugated or inflected. Further, words may be replaced with synonyms.

Further, when not only single-turn question answering but also multi-turn question answering is performed between the customer and the question answering program, question-answer pair data corresponding to the exchange of the question and the answer can be created according to another method of generating question-answer pair data. For example, an earlier application (JP-2020-80025-A) of the present applicant discloses a method of generating question-answer pair data. In this method, when a conversation including conditional branches is held or a conversation takes place by acquiring information necessary to answer a question from a customer and answering the question after all the necessary information is acquired, question-answer pair data corresponding to such conversation is generated. Meanwhile, according to the third embodiment, the question-answer pair generation program 25 recognizes that the disk is abnormal, in reference to the entry 1121 in the equipment operation information table 1100 illustrated in FIG. 11, so that the question-answer pair generation program 25 can generate question-answer pair data by taking into consideration the operating status of the disk as well as conditional branches or information required to be acquired.

Further, in the third embodiment, as another method of generating question-answer pair data, the following method is also applicable. Specifically, in searching the document 80 for a description in Step 650 illustrated in FIG. 6 and FIG. 8, the candidates may be narrowed down on the basis of the contents in the equipment operation information table 1100 illustrated in FIG. 11. For example, sentences, chapters, or paragraphs in the document 80 can be narrowed down to those related to abnormal disks on the basis of the entry 1121 of FIG. 11, and then, a description similar to the question sentences X1, . . . , and Xn can be searched for.

Moreover, in the third embodiment, question-answer pair data can automatically be generated such that the question-answer pair data includes, other than sentences that the customer has input to the question answering program 21, question sentences including the status of the equipment at that time point. With this, a more appropriate answer can be given to a question sentence based on the status of the equipment.

### Fourth Embodiment

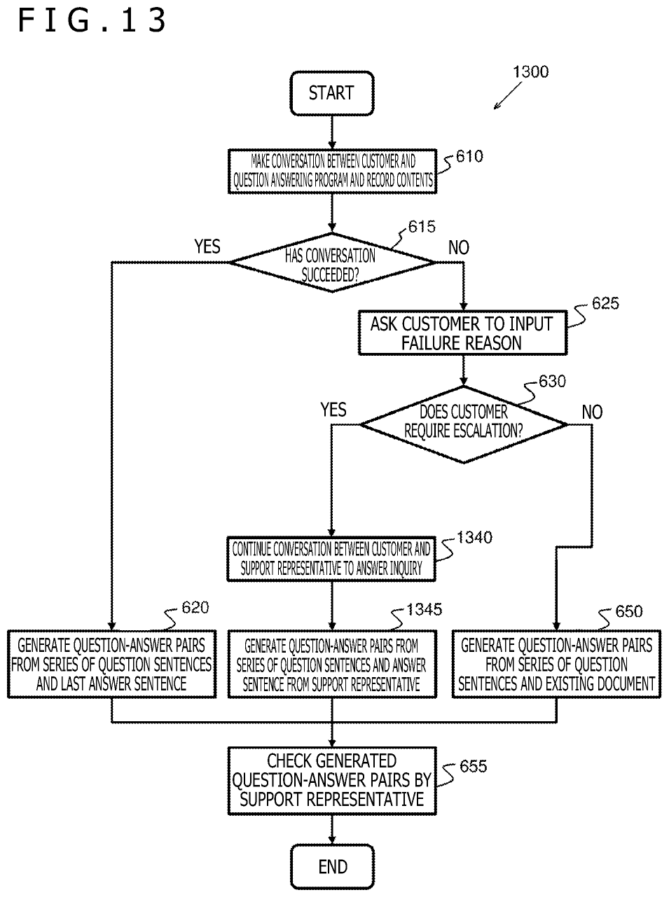

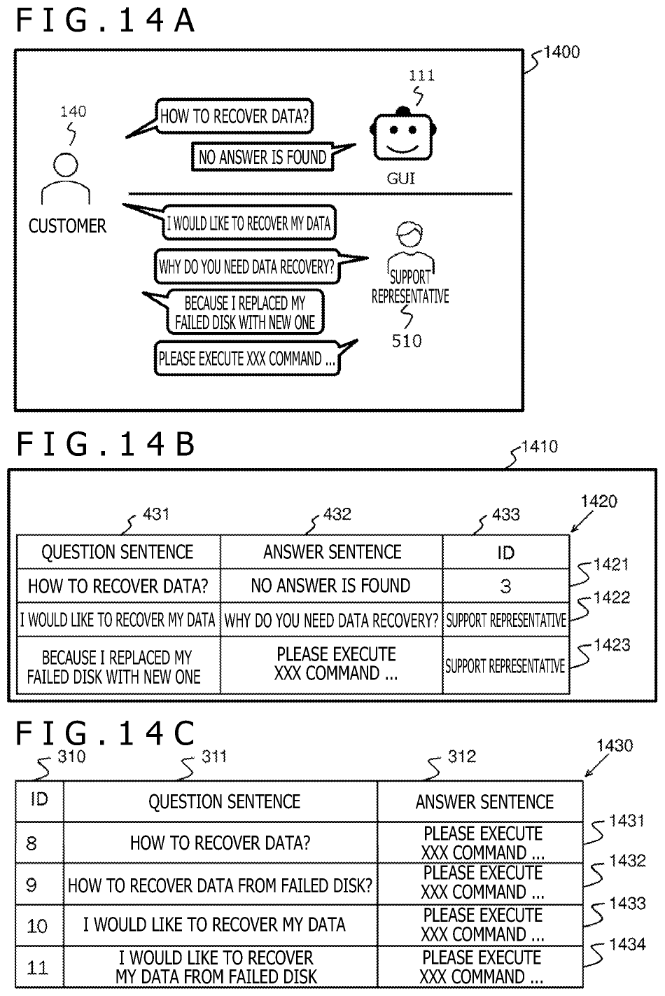

Next, a fourth embodiment of the present invention will be described with reference to FIG. 13 and FIGS. 14A to 14C. When the question answering computer 10 fails to give an answer expected by the customer, the support representative may take over the conversation on the spot. The fourth embodiment relates to an automatic question-answer pair data generation procedure when the support representative takes over a conversation.

FIG. 13 is a flowchart illustrating a question-answer pair generation processing procedure in the fourth embodiment. A question-answer pair generation processing flow 1300 is different from the question-answer pair generation processing flow 600 illustrated in FIG. 6 in the processing after the customer 140 answers in Step 630 that the customer 140 requires the escalation. Specifically, Steps 635, 640, and 645 of FIG. 6 are replaced with Steps 1340 and 1345. The other steps in FIG. 13 are the same as those in the procedure illustrated in FIG. 6, and identical steps are denoted by the same reference signs. A repetitive description is omitted. Now, Steps 1340 and 1345 are described.

In Step 1340, the conversation between the customer 140 and the question answering program 21 using the GUI 111 ends, and the support representative 510 takes over the conversation to answer the question from the customer 140 thereafter. After the support representative 510 has taken over the conversation, the conversation between the customer 140 and the support representative 510 may continue via the GUI 111, which has been used until then, or via another medium using sentences or voice. The medium is, however, required to be capable of recording the conversation between the customer 140 and the support representative 510 as characters. The recording of the conversation in the conversation history 400 continues after the conversation with the question answering program 21 ends and the conversation between the customer 140 and the support representative 510 starts. In general, in the conversation between the customer 140 and the support representative 510, one of the customer 140 and the support representative 510 asks a question, and the other answers the question. This is repeated a plurality of times. Although an initial inquiry is made by the customer 140, the support representative 510 may also ask the customer 140 about the status of the equipment or the like to resolve the problem. When the problem about which the customer 140 has inquired is resolved eventually through the conversation with the support representative 510, the conversation between the customer 140 and the support representative 510 ends.

In Step 1345, the question-answer pair generation program 25 illustrated in FIG. 2 generates question-answer pairs by combining the question sentences from the customer 140 that are recorded in the conversation history 400, with the answer sentence given by the support representative 510. The question sentences from the customer 140 can include both the question sentences that the customer 140 has first input to the question answering program 21 and the question sentences input to the support representative 510. Further, the question sentences from the customer 140 can also include what the support representative 510 has asked the customer 140 to resolve the problem, such as the status of the equipment.

FIGS. 14A to 14C illustrate an example of generating question-answer pairs from a conversation according to the question-answer pair generation processing flow 1300 in the fourth embodiment. A conversation 1400 illustrated in FIG. 14A is an example of the conversation between the customer 140 and the GUI 111 provided by the question answering program 21 and a conversation between the customer 140 and the support representative 510 after the support representative 510 has taken over the conversation. In the conversation 1400, the customer 140 first asks “how to recover data?” and the GUI 111 answers “no answer is found.” After the support representative 510 has taken over the conversation, the customer 140 tells the support representative 510 that “I would like to recover my data.” In response to this, the support representative 510 asks a question “why do you need data recovery?” The customer 140 answers “because I replaced my failed disk with a new one,” and the support representative 510 then gives a specific answer “please execute the XXX command . . . ” as a solution.

A conversation history 1410 illustrated in FIG. 14B is an excerpt of the contents in the conversation history data 40 (see FIG. 2) corresponding to the conversation described above. The details of the conversation are recorded in conversation details 1420. The question sentences 431 are the contents of the questions input by the customer 140, and the answer sentences 432 are the answers from the GUI 111 or the support representative 510. The question sentences 431 and the answer sentences 432 are stored in association with each other. Hence, as the answer sentence 432 from the support representative 510 in an entry 1422, a question sentence “why do you need data recovery?” is described on the answer sentence 432 side. As each of the IDs 433 stored in entries 1421, 1422, and 1423, an identification number (here, a natural number) or “support representative” is described. When an answer is given from the GUI 111, the entry is provided with an identification number which is given when the answer is given. When an answer is given from the support representative 510, the entry is provided with “support representative.” In this case, instead of “support representative,” the name of the support representative 510 or information identifying the support representative (an employee number or the like) may be input.

A question-answer pair database 1430 illustrated in FIG. 14C indicates question-answer pairs that the question-answer pair generation program 25 illustrated in FIG. 2 has generated from the conversation details 1420. In an entry 1431, the question sentence in the entry 1421, which the customer 140 has asked the GUI 111, and the answer sentence in the entry 1423 given by the support representative 510 are combined. In an entry 1433, the question sentence in the entry 1422, which the customer 140 has asked the support representative 510, and the answer sentence in the entry 1423 given by the support representative 510 are combined. In the entry 1422, as the answer sentence from the support representative 510, the support representative 510 asks a question. In the next entry 1423, as the question sentence from the customer 140, the customer 140 answers the question from the support representative 510. For this reason, question-answer pairs incorporating the contents of this conversation are made as entries 1432 and 1434. The entries 1432 and 1434 have question sentences obtained as follows. Specifically, a part of the question sentence from the customer 140 in the entry 1423 (the answer to the question from the support representative 510) is extracted and processed, thereby obtaining a phrase “from the failed disk.” Then, the phrase “from the failed disk” is added to the end of each of the question sentences in the entries 1431 and 1433.

As described above, to obtain the question sentences of the entries 1432 and 1434, a part of the question sentence from the customer 140 in the entry 1423 (the answer to the question from the support representative 510) is extracted and processed, and the resultant phrase is added to the question sentences of the question-answer pairs. However, the contents of question-answer pairs for use in multi-turn question answering as described in the third embodiment may be incorporated. For example, when questions and answers are exchanged, an additional question for checking whether a disk is broken can be made in the conversation.

As described above, according to the fourth embodiment, when the support representative has taken over the conversation between the customer and the question answering program 21 and has answered the inquiry from the customer on the spot, the question-answer pair generation program 25 combines the question sentences that the customer has input to the question answering program 21 and to the support representative, with the answer sentence from the support representative, thereby generating question-answer pairs. By using the question-answer pairs, the question-answer pair generation program 25 can automatically generate additional question-answer pairs as illustrated in FIG. 14C, with reduced man-hours.

### Fifth Embodiment

Next, a fifth embodiment of the present invention will be described. In the fifth embodiment, when the conversation between the customer 140 and the question answering program 21 has failed, the question answering program 21 (see FIG. 2) acquires the reason why the customer 140 has determined that the conversation has failed (answer failure reason), and updates the existing question-answer pairs. The question answering program 21 can acquire the reason by presenting a plurality of possible failure reasons and causing the questioner to select one of the failure reasons, for example.

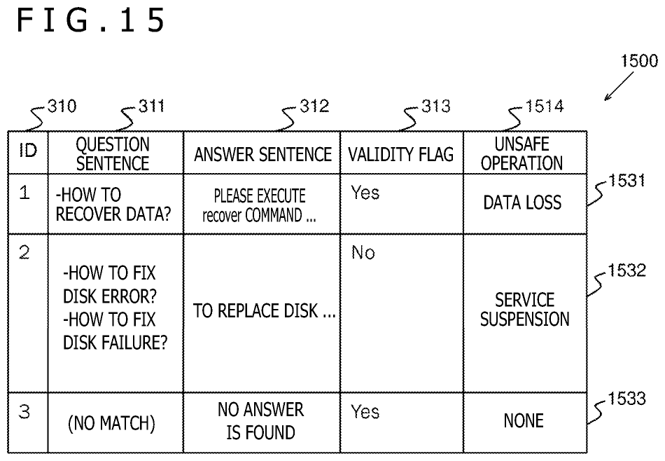

FIG. 15 illustrates an example of question-answer pair data 1500 according to the present embodiment. In the question-answer pair data 1500, a single column item, namely, an “unsafe operation 1514,” is added to each entry in the question-answer pair data 300 illustrated in FIG. 3. The unsafe operation 1514 represents a trouble which may be caused to the equipment or the customer when the instruction indicated by the answer sentence 312 is implemented. When giving the answer sentence 312 to the customer 140 through a conversation, the question answering program 21 can perform, depending on how serious the trouble indicated by the unsafe operation 1514 is, the processing of giving a warning sentence indicating that the answer sentence 312 includes an unsafe operation, or preventing the answer sentence 312 in question from being given to the customer 140, for example.

Whether or not to use the item “unsafe operation 1514” may individually be set by the support representative 510 referring to the answer sentences 312, or the item “unsafe operation 1514” may automatically be given on the basis of the analysis of the answer sentences 312 based on the unsafe operation expression model 90. In this way, for each of the answer sentences 312 in entries 1531 to 1533, information regarding the unsafe operation 1514 and the validity flag 313 indicating whether or not to use the information are input. In the entry 1533, since there is no information regarding the unsafe operation 1514, “none” is herein recorded.

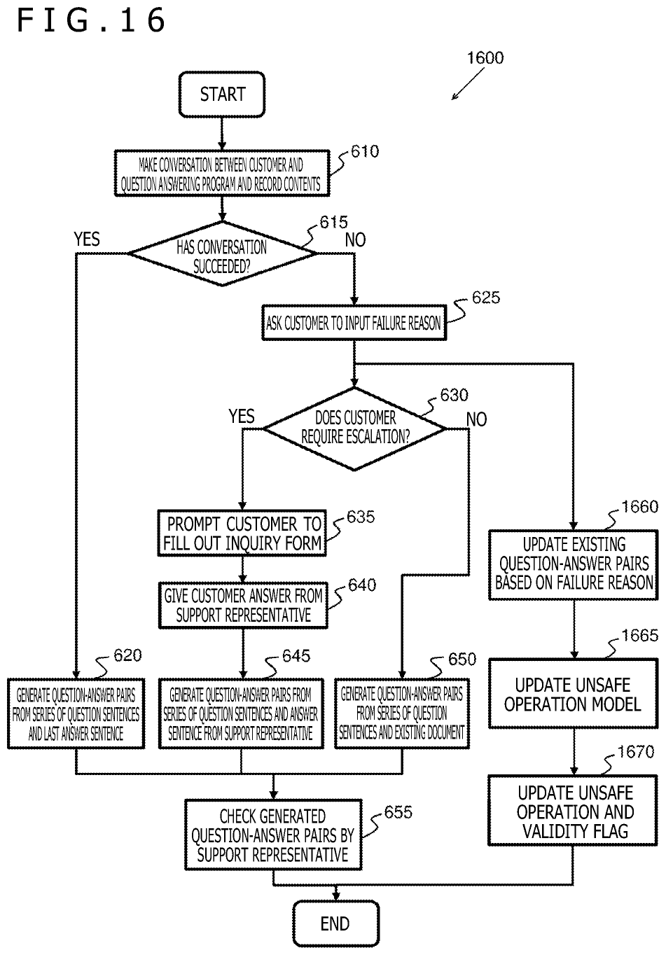

FIG. 16 illustrates a question-answer pair generation processing flow 1600. In the question-answer pair generation processing flow 1600, Steps 1660, 1665, and 1670 are added to the question-answer pair generation processing flow 600 according to the first embodiment illustrated in FIG. 6. Steps 1660, 1665, and 1670 are added after Step 625 in parallel with Step 630 and the subsequent steps and executed in parallel with the processing in Steps 635 and 640 and the like. The processing in the steps other than Steps 1660, 1665, and 1670 is the same as that of FIG. 6, and a repetitive description is omitted. Steps 1660, 1665, and 1670 are described.

In Step 1660, the question-answer pair generation program 25 refers to the ID 433, the (answer) result stored in the entry 425, and the (answer) failure reason stored in the entry 427, which have been recorded in the conversation history 400 illustrated in FIG. 4, and updates, when the conversation has failed, the unsafe operation 1514 or the validity flag 313 in the entry corresponding to the ID 433. The unsafe operation 1514 is updated when a failure reason indicating an adverse effect on the equipment operation, such as “the data may be lost” or “the service may stop,” is stored in the entry 427. The validity flag 313 is set to “No” when a failure reason indicating an error in an answer sentence, such as “no answer sentence is provided” or “the answer sentence does not have useful information,” is stored in the entry 427. In this procedure, the unsafe operation 1514 or the validity flag 313 may not be immediately updated on the basis of a single failure reason, but be updated when the same failure reason accounts for a certain percentage or more of a plurality of accumulated reasons.

In Step 1665, the question-answer pair generation program 25 collects entries having a plurality of question-answer pairs with the same failure reason as that in the entry 427 (see FIG. 4) and updates the unsafe operation expression model 90, which is illustrated in FIG. 2, on the basis of a common point among the entries. For example, words or idioms that frequently appear in the answer sentences of the plurality of question-answer pairs can be extracted, or a classification model based on unsafe operations that are potentially included in sentences can be constructed by performing machine learning on the answer sentences.

In Step 1670, the question-answer pair generation program 25 classifies the question sentences and answer sentences in the existing question-answer pair data 1500 by using the unsafe operation expression model 90 updated in Step 1665. When an entry that has not been given a specific unsafe operation 1514 until now is determined to belong to the same class as an entry group given a different unsafe operation 1514, the entry that has not been given the unsafe operation 1514 is given the unsafe operation 1514 similar to that given to the entry group. The validity flag 313 is also updated on the basis of the classification result.

According to the fifth embodiment, the automatic question answering system can update the attributes (unsafe operations or validity flags) of the existing question-answer pairs on the basis of an answer failure reason described by the customer. That is, a more appropriate answer can be given to the same question sentence thereafter by utilizing the answer failure reason.

What is claimed is:

1. A question-answer pair data generation method for an automatic question answering system,
the automatic question answering system including
a question-answer pair generation processing unit configured to prepare a question-answer pair in which a question sentence is associated with an answer sentence for automatically giving an answer to the question sentence,
a storage device configured to store the question-answer pair, and
a processing device configured to retrieve, from the question-answer pair, an answer sentence corresponding to a question from a questioner and give the questioner the retrieved answer sentence corresponding to the question,
the method comprising:
by the processing device,
escalating the question to a support representative when the automatic question answering system has failed to give an appropriate answer to the questioner in a question-and-answer session with the questioner;
acquiring a question sentence that the questioner has given to the support representative and an answer sentence that the support representative has given to the questioner; and
generating a new question-answer pair by combining the acquired question sentence and answer sentence with each other, and adding and storing the new question-answer pair to and in the storage device.

2. The question-answer pair data generation method according to claim 1,
wherein the processing device stores, in the storage device, a plurality of answer failure question sentences that the questioner has given to the automatic question answering system and that the automatic question answering system has failed to answer, and
the processing device additionally generates a new question-answer pair by reusing the answer failure question sentences and adds and stores the new question-answer pair to and in the storage device.

3. The question-answer pair data generation method according to claim 2,
wherein the processing device stores, in the storage device, equipment information regarding information equipment owned by the questioner, and
the processing device selects, when answering the question from the questioner, the answer sentence on a basis of the information equipment obtained from the storage device.

4. The question-answer pair data generation method according to claim 3, wherein the question-answer pair is a single question-answer pair generated by use of one or more question sentences and one or more answer sentences that are acquired when a question and an answer are exchanged with the questioner a plurality of times, and then stored in the storage device.

5. The question-answer pair data generation method according to claim 4,
wherein, when the question is escalated from an automatic answering operation by the automatic question answering system to the support representative, the processing device acquires both a plurality of question sentences that the questioner has given to the automatic question answering system through trial and error and a question sentence that the questioner has given to the support representative, the plurality of question sentences including a question sentence that the automatic question answering system has failed to answer, and
the processing device generates the new question-answer pair by reusing the acquired question sentences and a corresponding answer sentence.

6. The question-answer pair data generation method according to claim 5, wherein the processing device acquires an answer sentence used when the support representative has asked a question back, to generate a question-answer pair for use in multi-turn question answering.

7. The question-answer pair data generation method according to claim 6,
wherein, when the questioner has given a plurality of question sentences to the automatic question answering system and obtained an appropriate answer therefrom,
the processing device generates a single question-answer pair by combining the plurality of question sentences input thereto with a last answer sentence given by the automatic question answering system and stores the new question-answer pair in the storage device.

8. The question-answer pair data generation method according to claim 6,
wherein, when the questioner has asked the automatic question answering system a question and obtained an appropriate answer therefrom,
the processing device generates a new question-answer pair by combining an answer sentence used when the automatic question answering system currently successfully answers the question from the questioner, with a question sentence that the automatic question answering system has failed to answer in a past and to which no answer sentence has been allocated, and stores the new question-answer pair in the storage device.

9. The question-answer pair data generation method according to claim 8,
wherein, when the questioner has given a plurality of question sentences to the automatic question answering system and has not obtained an appropriate answer therefrom,
a sentence similar to any of the plurality of question sentences input by the questioner to the automatic question answering system is retrieved and extracted from an existing document, and
the plurality of question sentences input by the questioner to the automatic question answering system and the extracted similar sentence are stored in the storage device as a new question-answer pair.

10. The question-answer pair data generation method according to claim 6, further comprising:
generating a question-answer pair for use in the automatic question answering system,
wherein, when the questioner has asked the automatic question answering system a question and has not obtained an appropriate answer therefrom,
the automatic question answering system
asks the questioner for a reason the answer is determined to be inappropriate, and
generates a new question-answer pair by adding an attribute corresponding to the determination reason to a question-answer pair used by the automatic question answering system to answer the question from the questioner, and stores the new question-answer pair in the storage device.

11. The question-answer pair data generation method according to claim 6,
wherein, when a plurality of question-answer pairs including a same reason given by the questioner,
a classification model is created by performing statistical processing or machine learning on the plurality of question-answer pairs and is applied to other question-answer pairs, and a new question-answer pair is generated by adding an equivalent attribute to another question-answer pair that is determined to belong to a same class as the question-answer pairs including the same reason, and is stored in the storage device.

12. An automatic question answering system configured to prepare a question-answer pair for automatically giving an answer to a question and send an optimal answer to a question from a questioner by using the prepared question-answer pair, the automatic question answering system comprising:
an input unit configured to receive input from the questioner;
an output unit configured to present the answer to the questioner;
a question-answer pair generation processing unit configured to prepare a question-answer pair in which a question sentence is associated with an answer sentence for automatically giving an answer to the question sentence;
a storage device configured to store the question-answer pair; and
a processing device configured to retrieve, from the question-answer pair, an answer to the question from the questioner and give the questioner the retrieved answer,
wherein, when the question is escalated to a support representative as a result of an automatic question answering operation for the questioner, the question-answer pair generation processing unit acquires a question sentence that has been input by the questioner in a question-and-answer session between the questioner and the support representative, and an answer sentence that the support representative has given to the questioner, and generates a new question-answer pair by using the answer.

13. The automatic question answering system according to claim 12,
wherein an equipment operation information database related to information equipment owned by the questioner is provided, and
the processing device narrows down answers to an answer corresponding to the information equipment of the questioner acquired from the equipment operation information database.

14. An automatic question answering program for causing a computer to execute:
a question-answer pair program for preparing a question-answer pair in which a question sentence is associated with an answer sentence for automatically giving an answer to the question sentence;
a conversation history management program for storing the question-answer pair in a storage device;
the question-answer pair program for retrieving, from the question-answer pair, an answer to a question from a questioner and giving the questioner the retrieved answer; and
a question-answer pair generation program for acquiring, in a case where the questioner has not obtained an appropriate answer to a question in a question-and-answer session and where the question has been escalated to a support representative, a question sentence and an answer sentence that have been exchanged between the support representative and the questioner, generating a new question-answer pair by combining the question sentence with the answer sentence, and storing the new question-answer pair in the storage device.

15. The automatic question answering program according to claim 14,
wherein the conversation history management program causes the computer to store, in the storage device, both an answer success question sentence used by the questioner when an appropriate answer is given, and an answer failure question sentence used by the questioner when an appropriate answer is not given, and
the question-answer pair generation program causes the computer to generate a new question-answer pair by reusing the answer failure question sentence.
